(19) United States
(12) Patent Application Publication
(10) Pub. No.: US 2020/0390300 A1
(43) Pub. Date: Dec. 17, 2020

(54) Foot Support for a Toilet

(71) Applicant: Medic, Inc., Provo, UT (US)

(72) Inventors: David R. Hall, Provo, UT (US); Joshua Larsen, Spanish Fork, UT (US); Jared Reynolds, Spanish, UT (US); David Crismon, Herriman, UT (US)

(73) Assignee: Medic, Inc., Provo, UT (US)

(21) Appl. No.: 16/903,906

(22) Filed: Jun. 17, 2020

Related U.S. Application Data
(60) Provisional application No. 62/862,615, filed on Jun. 17, 2019.

(51) Int. Cl. A47K 17/02; H04N 5/225

(52) U.S. Cl. CPC A47K 17/028; G01S 15/89; H04N 5/2253

(57) ABSTRACT

A foot support for a toilet comprising a foot platform for supporting the feet of a user sitting on the toilet: and a lifting mechanism to raise and lower the foot platform; wherein the lifting mechanism further comprises two side arms disposed to either side of the foot platform; and a first actuator rotatably attached to a first end of each of the two side arms for lifting the platform is disclosed. A toilet with a foot support comprising a bowl for receiving excreta from a user; a seat for a user to sit upon above the bowl; a foot platform for supporting the feet of a user sitting on the toilet: and a lifting mechanism to raise and lower the foot platform

### CROSS-REFERENCE TO RELATED APPLICATIONS

This application claims priority to U.S. Provisional Application No. 62/862,615 titled “Height Adjustable Foot Support for Use with Toilet” filed on Jun. 17, 2019, which is incorporated herein by reference in its entirety.

### TECHNICAL FIELD

The present disclosure relates to the field of devices useful in assessing health and wellness. More particularly, it relates to the use of imaging technology on legs and feet to assess health and wellness.

### BACKGROUND

Not all people have the same height or body dimensions. However, nearly all toilets come in only a very small variety of heights. This can make it particularly difficult or uncomfortable for those who are among the tallest and shortest, or more specifically those with the longest and shortest legs, to lower down, sit, or rise from the toilet seat. Conventional toilets also lack any way to adjust the height of the feet. Raising the feet can only be accomplished with stools, typically having a fixed height.

The ability to track an individual's health and wellness is currently limited to the lack of available data related to personal health. Many diagnostic tools are based on examination and testing of excreta, but the high cost of frequent doctor's visits and/or scans make these options available only on a very limited and infrequent basis. Thus, they are not widely available to people interested in tracking their own personal wellbeing.

Toilets present a fertile environment for locating a variety of useful sensors to detect, analyze, and track trends for multiple health conditions. Locating sensors in such a location allows for passive observation and tracking on a regular basis of daily visits without the necessity of visiting a medical clinic for collection of samples and data. Monitoring trends over time of health conditions supports continual wellness monitoring and maintenance rather than waiting for symptoms to appear and become severe enough to motivate a person to seek care. At that point, preventative care may be eliminated as an option leaving only more intrusive and potentially less effective curative treatments. An ounce of prevention is worth a pound of cure.

Just a few examples of smart toilets and other bathroom devices can be seen in the following U.S. Patents and Published Applications: U.S. Pat. No. 9,867,513, entitled “MEDICAL TOILET WITH USER AUTHENTICATION”; U.S. Pat. No. 10,123,784, entitled “IN SITU SPECIMEN COLLECTION RECEPTACLE IN A TOILET AND BEING IN COMMUNICATION WITH A SPECTRAL ANALYZER”; U.S. Pat. No. 10,273,674, entitled “TOILET BOWL FOR SEPARATING FECAL MATTER AND URINE FOR COLLECTION AND ANALYSIS”; US 2016/0000378, entitled “HUMAN HEALTH PROPERTY MONITORING SYSTEM”; US 2018/0020984, entitled “METHOD OF MONITORING HEALTH WHILE USING A TOILET”; US 2018/0055488, entitled “TOILET VOLATILE ORGANIC COMPOUND ANALYSIS SYSTEM FOR URINE”; US 2018/0078191, entitled “MEDICAL TOILET FOR COLLECTING AND ANALYZING MULTIPLE METRICS”; US 2018/0140284, entitled “MEDICAL TOILET WITH USER CUSTOMIZED HEALTH METRIC VALIDATION SYSTEM”; US 2018/0165417, entitled “BATHROOM TELEMEDICINE STATION”; U.S. Ser. No. 15/222,267, entitled “THIN WEIGHT SCALE.” The disclosures of all of these patents and applications are incorporated by reference in their entireties.

### SUMMARY

In a first aspect, the disclosure provides a

In a second aspect, the disclosure provides a

Further aspects and embodiments are provided in the foregoing drawings, detailed description, and claims.

### BRIEF DESCRIPTION OF THE DRAWINGS

The following drawings are provided to illustrate certain embodiments described herein. The drawings are merely illustrative and are not intended to limit the scope of claimed inventions and are not intended to show every potential feature or embodiment of the claimed inventions. The drawings are not necessarily drawn to scale; in some instances, certain elements of the drawing may be enlarged with respect to other elements of the drawing for purposes of illustration.

FIG. 1 is a perspective view of a first exemplary toilet according to the present disclosure in a closed position.

FIG. 2 is a perspective view of the toilet of FIG. 1 with the lid opened and an exemplary embodiment of handles deployed.

FIG. 3 is a side plan view of a second exemplary toilet according to the present disclosure with the shroud removed and the seat in a lowered position for sitting.

FIG. 4 is a side plan view of the toilet of FIG. 3 with the foot platform elevated above the floor.

FIG. 5 is a perspective view of the toilet of FIG. 3 showing

FIG. 6 is a perspective view of an exemplary embodiment of a platform for lifting and scanning a toilet user's feet according to the present disclosure.

### DETAILED DESCRIPTION

The following description recites various aspects and embodiments of the inventions disclosed herein. No particular embodiment is intended to define the scope of the invention. Rather, the embodiments provide non-limiting examples of various compositions, and methods that are included within the scope of the claimed inventions. The description is to be read from the perspective of one of ordinary skill in the art. Therefore, information that is well known to the ordinarily skilled artisan is not necessarily included.

### Definitions

The following terms and phrases have the meanings indicated below, unless otherwise provided herein. This disclosure may employ other terms and phrases not expressly defined herein. Such other terms and phrases shall have the meanings that they would possess within the context of this disclosure to those of ordinary skill in the art. In some instances, a term or phrase may be defined in the singular or plural. In such instances, it is understood that any term in the singular may include its plural counterpart and vice versa, unless expressly indicated to the contrary.

As used herein, the singular forms “a,” “an,” and “the” include plural referents unless the context clearly dictates otherwise. For example, reference to “a substituent” encompasses a single substituent as well as two or more substituents, and the like.

As used herein, “for example,” “for instance,” “such as,” or “including” are meant to introduce examples that further clarify more general subject matter. Unless otherwise expressly indicated, such examples are provided only as an aid for understanding embodiments illustrated in the present disclosure and are not meant to be limiting in any fashion. Nor do these phrases indicate any kind of preference for the disclosed embodiment.

As used herein, “front,” “back,” and “side” are used to describe the disclosed system and devices from the perspective of a user. In the present disclosure, the user is assumed to be seated unless otherwise shown or stated to be standing facing the toilet.

As used herein, the terms “foot” and “feet” are intended to have a relatively broad meaning and used to reference the foot, ankle, and, in some cases, the calf area (i.e., leg below the knee) of the user.

As used herein, “toilet” is meant to refer to any device or system for receiving human excreta, including urinals.

As used herein, the term “bowl” refers to the portion of a toilet that is designed to receive excreta.

As used herein, the term “base” refers to the portion of the toilet below and around the bowl supporting it.

As used herein, the term “user” refers to any individual who interacts with the toilet and deposits excreta therein.

As used herein, the term “excreta” refers to any substance released from the body of a user including urine, feces, menstrual discharge, saliva, expectorate, and anything contained or excreted therewith.

As used herein, the term “excretion profile” is meant to refer collectively to the rate of excretion at any moment in time of an excretion event and the total volume or mass of excreta as a function of time during an excretion event. The terms “defecation profile” and “urination profile” refer more specifically to the separate measurement of excreta from the anus and urethra, respectively.

As used herein, the term “sensor” is meant to refer to any device for detecting and/or measuring a property of a person or of a substance regardless of how that property is detected or measured, including the absence of a target molecule or characteristic. Sensors may use a variety of technologies including, but not limited to, MOS (metal oxide semiconductor), CMOS (complementary metal oxide semiconductor), CCD (charge-coupled device), FET (field-effect transistors), nano-FET, MOSFET (metal oxide semiconductor field-effect transistors), spectrometers, volume measurement devices, weight sensors, temperature gauges, chromatographs, mass spectrometers, IR (infrared) detector, near IR detector, visible light detectors, and electrodes, microphones, load cells, pressure gauges, PPG (photoplethysmogram), thermometers (including IR and thermocouples), rheometers, durometers, pH detectors, scent detectors gas, and analyzers.

As used herein, the term “imaging sensor” is meant to refer to any device for detecting and/or measuring a property of a person or of a substance that relies on electromagnetic radiation of any wavelength (e.g., visible light, infrared light, xray) or sound waves (e.g., ultrasound) to view the surface or interior of a user or substance. The term “imaging sensor” does not require that an image or picture is created or stored even if the sensor is capable of creating an image.

As used herein, the term “data connection” and similar terms are meant to refer to any wired or wireless means of transmitting analog or digital data and a data connection may refer to a connection within a toilet system or with devices outside the toilet.

As used herein, “[term]” is meant to refer to

### Exemplary Embodiments

The present disclosure relates to a toilet with a bowl and seat supported by a frame. The frame includes one or more lifting mechanisms adapted to raise and lower the seat and/or bowl. In some embodiments, there may be separate frames for supporting and adjusting the seat and for supporting and adjusting the bowl. Preferably, the lifting mechanism is further adapted to change the angle of the seat.

In a preferred embodiment, the toilet comprises a motorized seat lift that is integral with and internal to the toilet. It also provides customized lifting motions set to individual users preferences. The disclosed toilet looks and feels like a conventional toilet and can help prevent fall by keeping a person more supported during a lift and help them to their feet at a height appropriate for the individual.

In a preferred embodiment, the adjustable frame allows the toilet to be both shorter and taller than conventional toilets. This makes the toilet more comfortable and easier to use for both tall and short users, including children, without the need for special stools or spacers.

In various exemplary embodiments, the bowl is supported by a frame including at least one actuator. In various exemplary embodiments, the seat is supported a frame comprising at least one actuator. In various exemplary embodiments, the frame comprises two, three, four, or more actuators for the bowl and/or seat. In a more preferred embodiment, the frame comprises three pairs of actuators to move the seat. Preferably, the actuators are controlled by a digital controller that coordinates the actions of the actuators to thereby provide a smooth lifting and lower at the desired speed. More preferably, the controller is programmable, so that users can program the lifting and lowering of the seat to their preference. Even more preferably, the toilet includes a user identification module, so that the user is automatically identified as he or she approaches or sits on the toilet.

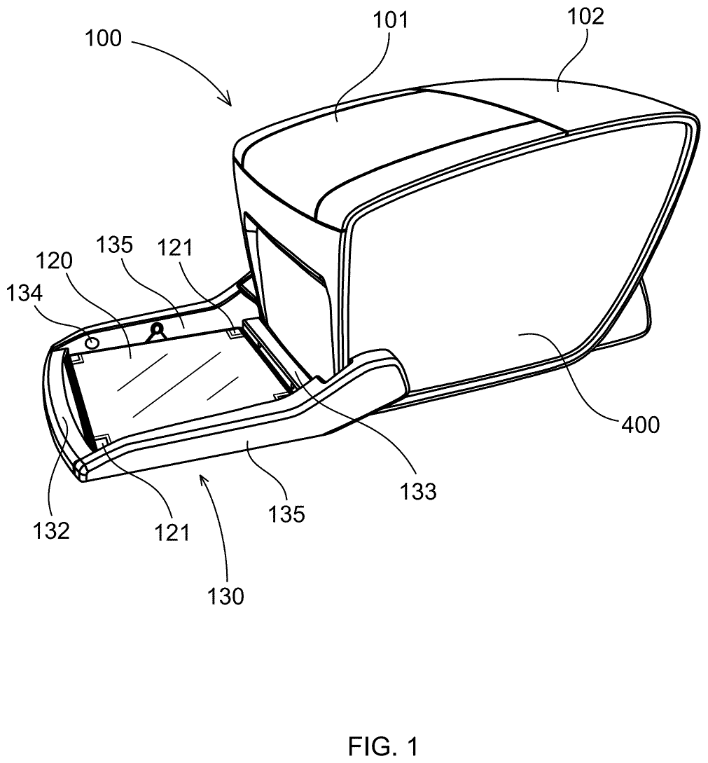

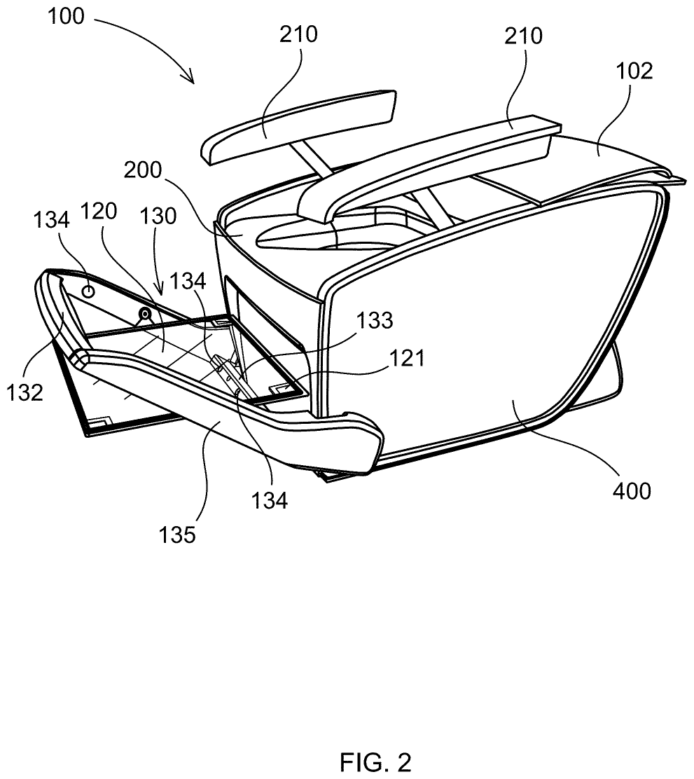

Referring to FIG. 1, an exemplary embodiment of a toilet 100 is shown with a closed lid 101, lowered foot platform 120, and retracted handles 210. FIG. 2 shows the toilet with an open lid 101, raised foot platform 120, and extended handles 210. In a preferred embodiment, handles 210 are adapted to be readily gripped by a user, especially while sitting or rising. In a preferred embodiment, the handles 210 move while the seat 200 is lowering and lifting a user to enable them to grip the handles 210 and use them for support during sitting and rising. The toilet is enclosed with a shroud 400.

In various exemplary embodiments, the handles 210 include one or more buttons, switches, sensors, etc. through which the user may control the seat, including, but not limited to, starting and stopping the seat 200, reversing seat movement direction, adjusting the position or angle of the seat 200, and adjusting the height of the bowl 300, seat 200, or foot platform 120.

In various exemplary embodiments, the handles 210 may include one or more health and wellness sensors. The sensors may be used to measure how hard the user is gripping and provide feedback to the lift control. For example, if a user suddenly increases their grip it is likely that they are struggling with standing or with their balance. Grip pressure may also be tracked over time. The sensors may also include detection for heart rate, body temperature, hand health indicators, cameras, electrocardiogram, pulse, blood test (e.g., using a finger prick), etc. Toilet handles with health and wellness sensors are disclosed in U.S. Patent Pub. No. 2018/0084959, the entire disclosure of which is incorporated herein by reference in its entirety.

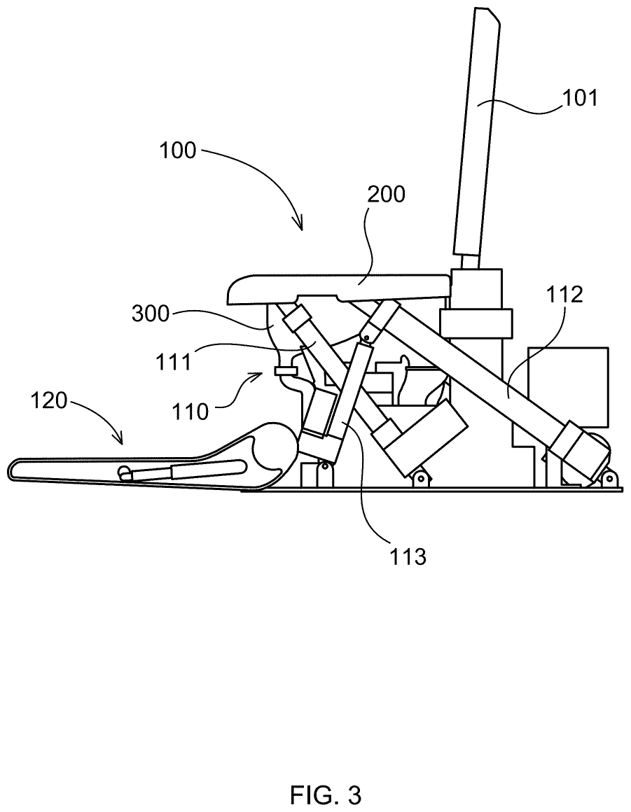

Referring to FIG. 3, an exemplary embodiment of a toilet 100 is shown with various seat elevations. The toilet 100 includes a frame 110, bowl 300 supported by the frame 110, a lid 101, and a seat 200 also supported by the frame 110. In a preferred embodiment, the seat 200 is supported by two sets of seat actuators 111, 112, and 113. In other embodiments, the number and arrangement of actuators may vary.

In a preferred embodiment, a pair of first seat actuators 111 are pivotally connected to a front area of the seat 200 and a pair of second seat actuators 112 are pivotally connected to a back area of the seat 200 providing support at four “corners” of the seat 200. The four seat actuators 111 and 112 are also pivotally attached to the frame 110. An additional pair of third seat actuators 113 are pivotally attached to the frame 110 at one end and pivotally attached to the second pair of seat actuators 112 at their other end. In another embodiment, the third actuators 113 are attached to the first pair of seat actuators 111.

The foot platform 120 is adapted to provide for imaging sensors 134 to examine a user's feet. Imaging sensors 134 are positioned above, to the sides, and below the user's feet on the arms 135, outer crossbar 132, and base crossbar 133. The imaging sensors 134 may be visible light, infrared, near infrared, thermal, and/or 3D sensors. The platform 120 is preferably comprised of a transparent material to facilitate the use of imaging sensors under the platform 120 for analyzing the bottom of the user's feet. A foot platform and imaging sensors of this type are described in U.S. patent application Ser. No. 16/578,118 filed on Sep. 20, 2019, which is incorporated herein by reference in its entirety.

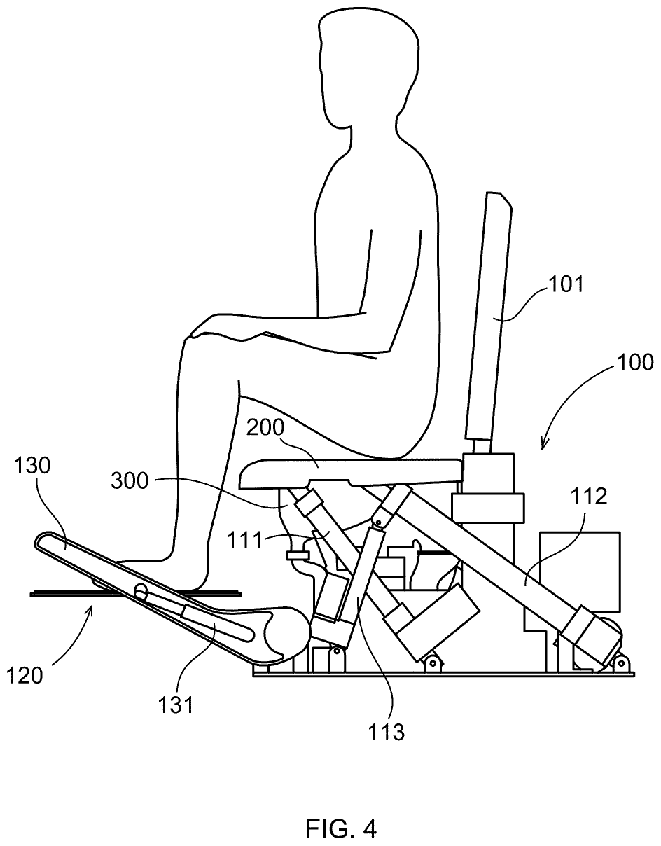

Referring to FIG. 4, the toilet 100 is shown with the foot platform 120 raised. In various exemplary embodiments, the platform 120 is raised and lowered by pivoting arms 135 using planetary gears (not shown). The angle of the foot platform 120 relative to the arms 135 is adjusted to keep the foot platform 120 level by actuators 131.

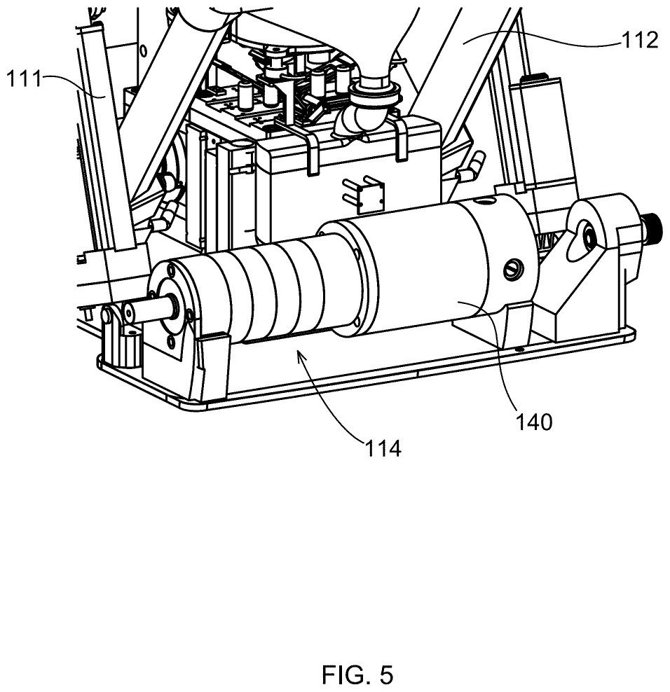

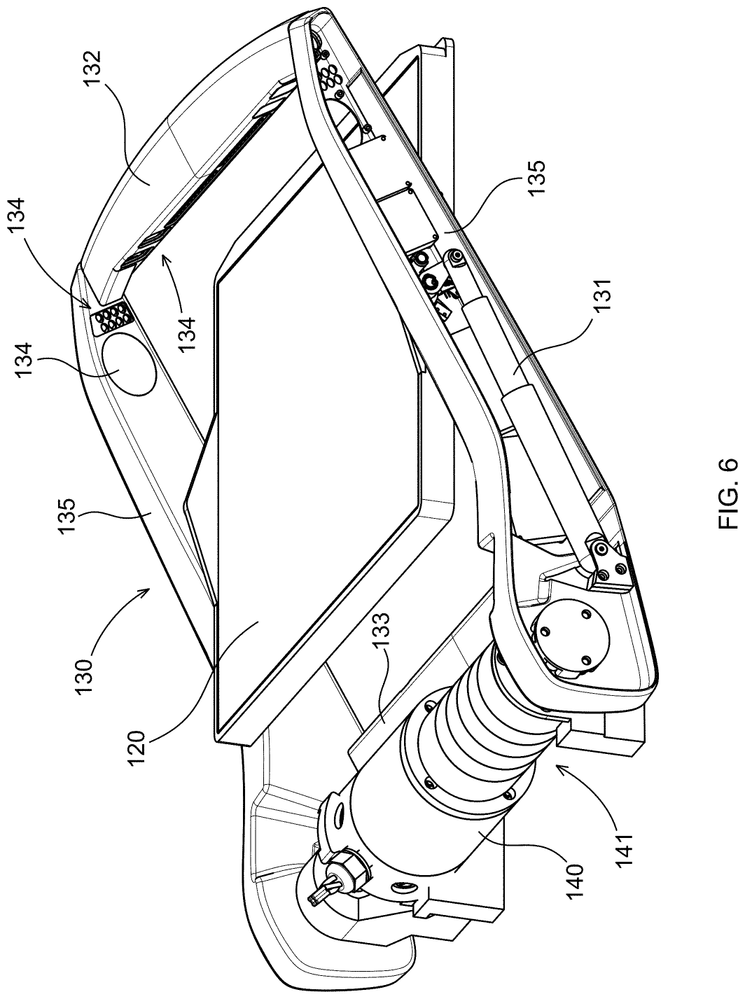

Referring to FIGS. 5 and 6, the platform 120 and mechanism for adjusting its height and attitude (i.e., angle relative to the platform frame) are shown. In a preferred embodiment, the platform 120 is pivotally connected to a platform frame 130 including actuators 131 that rotate the platform relative to the frame. The platform frame 130 is pivotally connected to a motor 140 by planetary gears 141 in the toilet frame 110.

In various exemplary embodiments, the angle of the foot platform frame 130 relative to the floor changes as it is pivoted by motor 140. Actuators 131 rotate the flatform 120 relative to the frame 120. This allows the platform 120 to be kept parallel to the floor at any height or to be adjusted to a different angle for greater comfort. This includes using the platform 120 to raise the knees to a more ergonomic position (i.e., “squatty potty”) or more comfortable angle for the feet and ankles.

In various exemplary embodiments, the toilet includes one or more sensors to examine the user or excreta. The sensor may be an imaging sensor, which is preferably one or more of, but not limited to, CCD (charge-coupled device) or MOS (metal oxide semiconductor), including CMOS (complementary metal oxide semiconductor), IR (infrared) detector, near IR detector, and visible light detectors. In various exemplary embodiments, a light source emits visible and/or non-visible light across one or more ranges of wavelengths as appropriate for any particular detection method (e.g., spectrometry). The sensor may also be one or more of, but not limited to, CCD, MOS/CMOS, spectrometers, chromatographs, FET, nano-FET, MOSFET, mass spectrometers, electrodes, microphones, load cells, pressure gauges, PPG, thermometers (including IR and thermocouples), rheometers, durometers, pH detectors, and scent detectors.

In accordance with the present disclosure, a smart toilet that includes mechanical, hydraulic, power, and data connections to accommodate a combination of health measuring tools is provided. An electrical connection to provide power to the health measuring tools is also provided.

In various exemplary embodiments, the smart toilet includes at least one sensor that analyzes imaging data. A processor analyzes the data to attempt to compare the user to known users for identification purposes. If a known user is identified, the position of the bowl and/or seat is automatically adjusted to the preferred position of the user. If the user is unknown or does not have a record preferred position, the processor analyzes the physical characteristics of the user (e.g., height, waist height, length of upper and lower legs) and adjusts the position of the bowl and/or seat accordingly. In some embodiments, facial recognition is used to identify users.

In the preferred embodiments, the toilet also includes health assessment devices supported by the frame. Examples of such devices include imaging cameras, flow spectrometers, volume measurement devices, body weight sensors, and gas analyzers. Toilets with such devices are described in the patents and published applications cited in the Background section above.

All patents, published patent applications, and other publications referred to herein are incorporated herein by reference. The invention has been described with reference to various specific and preferred embodiments and techniques. Nevertheless, it is understood that many variations and modifications may be made while remaining within the spirit and scope of the invention.

What is claimed is:

1. A foot support for a toilet comprising:
a foot platform for supporting the feet of a user sitting on the toilet: and
a lifting mechanism to raise and lower the foot platform;
wherein the lifting mechanism further comprises:
two side arms disposed to either side of the foot platform; and
a first actuator rotatably attached to a first end of each of the two side arms for lifting the platform.

2. The foot support of claim 1 further comprising a rotatable attachment between the side arms and the foot platform and a second actuator for rotating the foot platform relative to the two arms.

3. The foot support of claim 1 wherein the frame comprises a base crossbar attached to each of the two side arms adjacent to their first ends.

4. The foot support of claim 1 wherein the frame comprises an outer crossbar attached to each of the two side arms adjacent to their second ends.

5. The foot support of claim 1 wherein the height of the foot platform can be adjusted by the user.

6. The foot support of claim 1 wherein the angle of the foot platform relative to a horizontal plane can be adjusted by the user.

7. The foot support of claim 1 further comprising at least one imaging sensor.

8. The foot support of claim 7 wherein the at least one imaging sensor comprises at least one of an infrared imaging sensor, a near infrared imaging sensor, a visual camera, a 3D camera, and an ultrasonic 3D imaging sensor.

9. The foot support of claim 7 wherein the at least one imaging sensor is on a base crossbar attached to each of the two side arms adjacent to their first ends.

10. The foot support of claim 7 wherein the at least one imaging sensor is on an outer crossbar attached to each of the two side arms adjacent to their second ends.

11. The foot support of claim 7 wherein the at least one imaging sensor is on a base of the toilet.

12. The foot support of claim 7 further comprising a processor for receiving data from the at least one image sensors.

13. The foot support of claim 12 wherein the processor transmits the data to a remote location for analysis.

14. The foot support of claim 1 wherein the first actuator comprises planetary gears.

15. A toilet with a foot support comprising:
a bowl for receiving excreta from a user;
a seat for a user to sit upon above the bowl;
a foot platform for supporting the feet of a user sitting on the toilet: and
a lifting mechanism to raise and lower the foot platform.

16. The toilet of claim 15 further comprising a health and wellness sensor.

17. The toilet of claim 16 wherein the health and wellness sensor detects a property of excreta.

18. The toilet of claim 17 wherein the property of excreta is one or more of weight, color, consistency, volume, density, content, temperature, pH, size and shape, excretion profile, sounds, and gas or fumes.

19. The toilet of claim 16 wherein the health and wellness sensor is one or more of MOS/CMOS, CCD, spectrometers, volume measurement devices, weight sensors, temperature gauges, chromatographs, mass spectrometers, and gas analyzers.

20. The toilet of claim 15 wherein the lifting mechanism comprises:
two side arms disposed to either side of the foot platform;
a first actuator rotatably attached to a first end of each of the two side arms for lifting the platform;
a rotatable attachment between the side arms and the foot platform; and
a second actuator for rotating the foot platform relative to the two arms.
